(19) United States
(12) Patent Application Publication
(10) Pub. No.: US 2005/0190198 A1
(43) Pub. Date: Sep. 1, 2005

(54) Color correction circuit and image display device equipped with the same

(75) Inventor: Fumio Koyama, Shiojiri-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/062,881

(22) Filed: Feb. 23, 2005

(30) Foreign Application Priority Data
Mar. 1, 2004 (JP) 2004-055871

(51) Int. Cl. G09G 5/02

(52) U.S. Cl. 345/593; 382/167

(57) ABSTRACT

Aspects of the invention provide a color correction circuit that can reduce a memory capacity needed to create a look-up table while suppressing deterioration in accuracy of color correction. A three-dimensional look-up table can store, as the correction values, correction values corresponding to (2^{m}×2ⁿ×2^{o}) combinations specified by gradation steps represented by higher-order m bits (m is an integer equal to 1 or greater) of the luminance signal, gradation steps represented by higher-order n bits (n is an integer greater than m) of the first color difference signal, and gradation steps represented by higher-order o bits (o is an integer grater than m) of the second color difference signal, among (2^{j}×2^{k}×2^{l}) combinations specified by gradation steps of the j-bit (j is an integer equal to 2 or greater) luminance signal, gradation steps of the k-bit (k is an integer equal to 2 or greater) first color difference signal, and gradation steps of the l-bit (l is an integer equal to 2 or greater) second color difference signal.

### BACKGROUND

Aspects of the invention can relate to an image display device, such as a liquid crystal projector. More particularly, the invention can relate to a technique of correcting colors of a display image.

Related art liquid crystal projectors are image display devices, and in the case of a three-plate type, it can include, as display devices, three liquid crystal panels respectively for R (red), G (green), and B (blue). In such a related art liquid crystal projector, an illumination light emitted from an illumination system is separated into R-, G-, and B-lights of respective colors, which then go incident on liquid crystal panels of the corresponding colors. R-, G-, and B-signals, which are image signals, are inputted into the liquid crystal panels of the corresponding colors, and the incident color lights are allowed to pass through the liquid crystal panels driven according to these signals. After transmitted R-, G-, and B-lights (color lights) thus obtained from the three liquid crystal panels are combined, the combined lights are projected onto a screen by a projection system for a color image according to the R-, G-, and B-signals to be displayed on the screen.

Related art liquid crystal panels used in such a liquid crystal projector have properties that the wavelength characteristics of transmitted lights vary with a change in gradation steps of signals inputted therein. For instance, in an R-liquid crystal panel, the wavelength characteristics of an R-light having passed through the liquid crystal panel vary in association with a change in gradation steps of an R-signal inputted therein. The transmitted R-light then shows a color closer to magenta or closer to orange. That is to say, the chromaticity coordinates of the transmitted R-light, which are not supposed to vary with a change in gradation steps of an R-signal, do vary with a change in gradation steps. The same applies to the G- and B-liquid crystal panels when there is a change in gradation steps of a G-signal and a B-signal inputted therein.

As has been described, when the chromaticity coordinates of transmitted R-, G-, and B-lights vary with a change in gradation steps of R-, G-, and B-signals, there occurs a problem that exact color reproduction of an image according to R-, G-, and B-signals cannot be achieved. Such being the case, in order to achieve exact color reproduction of an image according to R-, G-, and B-signals, colors of color lights emitted from the display devices can be corrected in response to a change in gradation steps of R-, G-, and B-signals with the use of a color correction circuit comprising a three-dimensional look-up table (hereinafter, referred to also as 3D-LUT). See, for example, JP-2002-41016, JP-2002-140060, JP-2002-344761, and JP-2003-271122.

### SUMMARY

Each of R-, G-, and B-signals are normally in the form of gradation data of 8 bits or more, that is, gradation values of 256 steps or more. Hence, in order to correct colors of color lights emitted from the display devices in response to a change in gradation steps of R-, G-, and B-signals, a 3D-LUT needs to store (256×256×256) or more correction values to correspond to all the combinations of gradation steps of R-, G-, and B-signals. A very large memory capacity is therefore needed to form a color correction circuit including a 3D-LUT, which results in a circuit configuration of an extremely large scale with the current circuit techniques.

With this being the situation, when a 3D-LUT is created in practice, a necessary memory capacity is reduced with the configuration to store correction values corresponding not to all the combinations of gradation steps of R-, G-, and B-signals inputted therein, but to combinations of rough gradation steps obtained by dividing gradation steps of respective R-, G-, and B-signals at adequate intervals.

However, when a memory capacity forming the 3D-LUT is made smaller, an interval to divide the gradation steps of R-, G-, and B-signals has to become larger. This lessens the number of correction values specified by the combinations of the gradation steps of R-, G-, and B-signals, that is, the number of correction values that can be stored in the 3D-LUT, which in turn makes fine color corrections difficult. This results in a problem that accuracy of color correction becomes poor.

An aspect of the invention can provide a technique that solves the problems in the background art, and is thereby capable of reducing a memory capacity forming a look-up table while suppressing deterioration in accuracy of color correction.

An exemplary color correction circuit of the invention is a color correction circuit that can correct a color of an image displayed on an image display device. The device can include a color correction circuit portion, having a three-dimensional look-up table, to correct gradation steps of a luminance signal, a first color difference signal, and a second color difference signal with the use of correction values stored in the three-dimensional look-up table in response to combinations of gradation steps of the luminance signal, the first color difference signal, and the second color difference signal inputted therein, wherein the three-dimensional look-up table stores, as the correction values, correction values corresponding to (2^{m}×2ⁿ×2^{o}) combinations specified by gradation steps represented by higher-order m bits (m is an integer equal to 1 or greater) of the luminance signal, gradation steps represented by higher-order n bits (n is an integer greater than m) of the first color difference signal, and gradation steps represented by higher-order o bits (o is an integer grater than m) of the second color difference signal, among (2^{j}×2^{k}×2^{l}) combinations specified by gradation steps of the luminance signal of j bits ( is an integer equal to 2 or greater), gradation steps of the first color difference signal of k bits (k is an integer equal to 2 or greater), and gradation steps of the second color difference signal of l bits (l is an integer equal to 2 or greater).

In the color correction circuit of the invention, the three-dimensional look-up table is configured to store correction values corresponding to (2^{m}×2ⁿ×2^{o}) combinations specified by gradation steps represented by higher-order m bits of the luminance signal, gradation steps represented by higher-order n bits of the first color difference signal, and gradation steps represented by higher-order o bits of the second color difference signal, among (2^{j}×2^{k}×2^{l}) combinations specified by gradation steps of the j-bit luminance signal, gradation steps of the k-bit first color difference signal, and gradation steps of the l-bit second color difference signal. It is thus possible to lessen the number of gradation steps of the luminance signal specifying the correction values in comparison with the number of gradation steps of the first color difference signal and the number of gradation steps of the second color difference signal. Hence, according to the color correction circuit of the invention, it is possible to reduce a memory capacity needed to create the three-dimensional look-up table while suppressing deterioration in accuracy of color correction.

For the exemplary color correction circuit of the invention, it is possible to further include a first color conversion circuit portion to convert the luminance signal, the first color difference signal, and the second color difference signal, which have been corrected in the color correction circuit portion, to a red signal corresponding to red, a green signal corresponding to green, and a blue signal corresponding to blue.

As has been described, according to the exemplary color correction circuit of the invention, it is possible to output the luminance signal, the first color difference signal, and the second color difference signal, which have been corrected in the color correction circuit portion, by converting these signals to a red signal corresponding to red, a green signal corresponding to green, and a blue signal corresponding to blue. This can be favorable, for example, when signals to be inputted into display devices forming the image display device are a red signal, a green signal, and a blue signal.

Also, for the color correction circuit of the invention, it is preferable to further include a second color conversion circuit portion to convert the red signal, the green signal, and the blue signal inputted therein as image signals to the luminance signal, the first color difference signal, and the second color difference signal to be inputted into the color correction circuit portion.

As has been described, according to the color correction circuit of the invention, it is possible to convert the red signal, the green signal, and the blue signal inputted therein as image signals to the luminance signal, the first color difference signal, and the second color difference signal to be inputted into the color correction circuit portion. This can be favorable, for example, when a red signal, a green signal, and a blue signal are inputted as image signals.

Further, for the exemplary color correction circuit of the invention, it can be preferable that the three-dimensional look-up table stores, as the correction values, a luminance signal offset value, a first color difference signal offset value, and a second color difference signal offset value to be added, respectively, to the luminance signal, the first color difference signal, and the second color difference signal, and that the color correction circuit portion includes three addition circuits to add the luminance signal offset value, the first color difference signal offset value, and the second color difference offset value, respectively, to the corresponding luminance signal, first color difference signal, and second color difference signal.

By configuring the three-dimensional look-up table to store, as the correction values, the luminance signal offset value, the first color difference signal offset value, and the second color difference signal offset value to be added, respectively, to the luminance signal, the first color difference signal, and the second color difference signal as has been described, it is possible to further reduce a memory capacity needed to create a three-dimensional look-up table.

It should be understood that the invention is not limited to the use in the form of the color correction circuit as described above, and it can be implemented also in the form of an image display device equipped with the same.

### BRIEF DESCRIPTION OF THE DRAWINGS

The invention will be described with reference to the accompanying drawings, wherein like numerals reference like elements, and wherein:

FIG. 1 is an exemplary block diagram schematically showing the configuration of a liquid crystal projector to which a color correction circuit of the invention is applied; and

FIG. 2 is an exemplary block diagram showing the color correction circuit.

### DETAILED DESCRIPTION OF EMBODIMENTS

Hereinafter, one exemplary embodiment of the invention will be described according to an example in order as follows:
A. schematic configuration of liquid crystal projector;
B. color correction circuit; and
C. modifications.
   A. Schematic Configuration of Liquid Crystal Projector

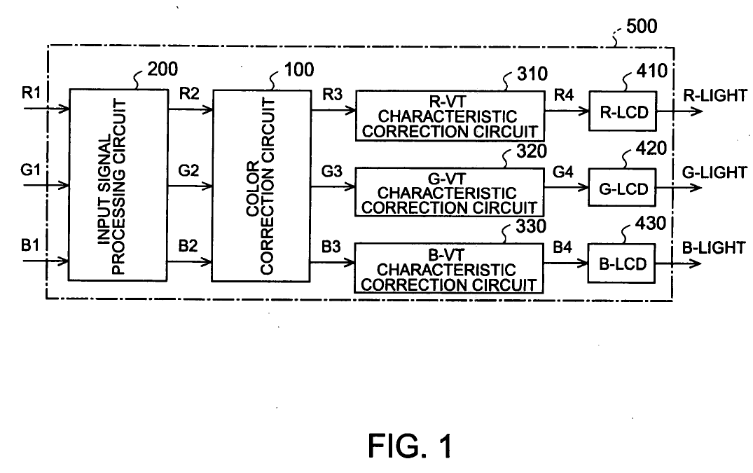

FIG. 1 is an exemplary block diagram schematically showing the configuration of a liquid crystal projector to which a color correction circuit of the invention can be applied. A liquid crystal projector 500 shown in FIG. 1 is of a so-called three-plate type, and includes, as display devices, three liquid crystal panels (hereinafter, referred to also as LCDs) 410 through 430 respectively for R (red), G (green), and B (blue). In addition to these, the liquid crystal projector 500 includes an input signal processing circuit 200, a color correction circuit 100 of the invention, and R-, G-, and B-VT characteristic correction circuits 310 through 330.

When R-, G-, and B-signals R1, G1, and B1 are inputted from the outside as image signals in the form of analog signals, the input signal processing circuit 200 performs analog-to-digital conversion and performs frame rate conversion or re-size processing according to the signal format of these signals, or superimposes a menu screen when a menu is to be displayed. When the input image signals are in the form of composite signals, it can demodulate the composite signals and perform processing to separate the signals into R-, G-, and B-signals and a synchronization signal.

The color correction circuit 100 then makes corrections on R-, G-, and B-signals R2, G2, and B2 outputted in the form of digital signals from the input signal processing circuit 200, and thereby corrects colors of transmitted lights (color lights) obtained by being emitted from the liquid crystal panels 410 through 430 and then combined.

Subsequently, the R-, G-, and B-VT characteristic correction circuits 310 through 330 independently apply γ correction to R-, G-, and B-signals R3, G3, and B3 outputted from the color correction circuit 100 with consideration given to VT characteristics (voltage-to-transmissivity characteristics) of the R-, G-, and B-liquid crystal panels 410 through 430. It should be noted that each of the R-, G-, and B-VT characteristic correction circuits 310 through 330 normally can include a one-dimensional look-up table (hereinafter, referred to also as 1D-LUT).

Meanwhile, the R-, G-, and B-liquid crystal panels 410 through 430 receive, respectively, R-, G-, and B-signals R4, G4, and B4 outputted from the VT characteristic correction circuits 310 through 330, and emit, respectively, transmitted R-, G-, and B-lights (color lights) according to these signals. To be more specific, after an illumination light emitted from an illumination system (not shown) is separated into R-, G-, and B-lights of respective colors, the respective color lights go incident on the liquid crystal panels 410 through 430 of the corresponding colors, while the R-, G-, and B-signals R4, G4, and B4 from the VT characteristic correction circuits 310 through 330 are inputted into the liquid crystal panels 410 through 430 of the corresponding colors. The liquid crystal panels are then driven according to these input color signals to transmit incident color lights.

Transmitted R-, G-, and B-lights (color lights) emitted respectively from the R-, G-, and B-liquid crystal panels 410 through 430 in this manner are combined, and then projected onto a screen (not shown) by a projection system (not shown) for a color image according to the R-, G-, and B-signals to be displayed on the screen.

B. Color Correction Circuit

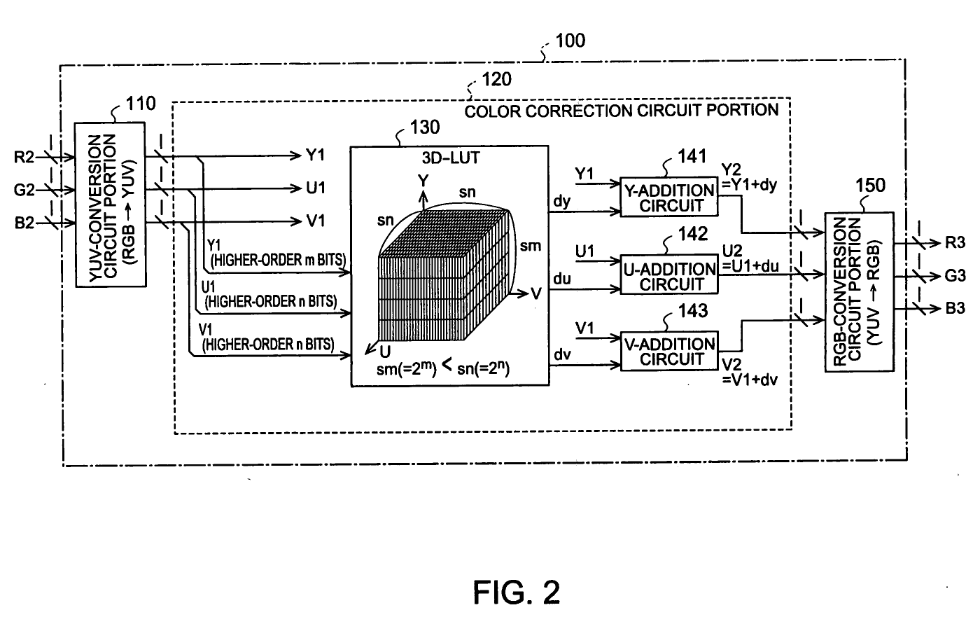

FIG. 2 is an exemplary block diagram showing the color correction circuit. As is shown in FIG. 2, the color correction circuit 100 can include a YUV conversion circuit portion 110, a color correction circuit portion 120, and an RGB conversion circuit portion 150.

The YUV conversion circuit portion 110 can include a typical matrix circuit to convert R-, G-, and B-signals to a luminance signal (Y-signal) indicating luminance (Y), a first color difference signal (U-signal) indicating a color difference (U) obtained by subtracting a Y-signal from a B-signal, and a second color difference signal (V-signal) indicating a color difference (V) obtained by subtracting a Y-signal from an R-signal. The YUV conversion circuit portion 110 converts 1-bit (l is an integer equal to 2 or greater) R-, G-, and B-signals R1, G1, and B1 inputted therein to 1-bit Y-, U-, and V-signals Y1, U1, and VI. The number of bits, l, is normally 1≧8.

The color correction circuit portion 120 can include a 3D-LUT 130 and Y-, U-, and V-addition circuits 141 through 143. The 3D-LUT 130 can be a memory circuit having stored an 1-bit Y-signal offset value dy, an 1-bit U-signal offset value du, and an 1-bit V-signal offset value dv, as correction values corresponding to combinations of higher-order m bits (m is an integer equal to 1 or greater) of a Y-signal, higher-order n bits (n is an integer greater than m) of a U-signal, and higher-order n bits of a V-signal, to output (3×1)-bit correction values in response to combinations of gradation steps of Y-, U-, and V-signals Y1, U1, and V1 inputted therein. Such a memory circuit can be achieved, with the use of a RAM having (m+n+n)-bit addresses, by allocating the (m+n+n)-bit addresses to higher-order m bits of a Y-signal, higher-order n bits of a U-signal, and higher-order n bits of a V-signal, sequentially from the higher-order bits, and by allocating (3×1)-bit outputs to the Y-signal offset value dy, the U-signal offset value du, and the V-signal offset value dv, for example, per 1 bits from the higher-order bits. The offset values dy, du, and dv can take positive values as well as negative values. In addition, because the respective offset values are extremely small values in general, it may be configured to output offset values having bits fewer than 1 bits.

The Y-, U-, and V-addition circuits 141 through 143 add, respectively, the offset values dy, du, and dv outputted from the 3D-LUT 130 to the corresponding Y-, U-, and V-signals Y1, U1, and V1, and thereby generate corrected Y-, U-, and V-signals Y2, U2, and V2.

As has been described, the color correction circuit portion 120 corrects the Y-, U-, and V-signals Y1, U1, and V1 outputted from the YUV conversion circuit portion 110 in response to combinations of gradation steps of the Y-, U-, and V-signals Y1, U1, and V1, and thereby output corrected Y-, U-, and V-signals Y2, U2, and V2.

The RGB conversion circuit portion 150 can include a typical matrix circuit to convert Y-, U-, and V-signals to R-, G-, and B-signals. The RGB conversion circuit 150 therefore converts the Y-, U-, and V-signals Y2, U2, and V2 outputted from the color correction circuit portion 120 back to R-, G-, and B-signals R3, G3, and B3.

As has been described, the color correction circuit 100 makes corrections on the R-, G-, and B-signals R2, G2, and B2 outputted from the input signal processing circuit 200, and corrects colors of transmitted lights (color lights) obtained by being emitted from the liquid crystal panels 410 through 430 and then combined.

As will be described below, the color correction circuit 100 can be characterized by the configuration of the 3D-LUT 130 forming the color correction circuit portion 120. Firstly, it can be characterized by the configuration to store correction values corresponding not to the combinations of gradation steps of R-, G-, and B-signals, but to the combinations of gradation steps of Y-, U-, and V-signals. Secondly, it can be characterized by the configuration to store correction values corresponding to (2^{m}×2ⁿ×2ⁿ) combinations specified by gradation steps represented by higher-order m bits of a Y-signal, gradation steps represented by higher-order n bits of a U-signal, and gradation steps represented by higher-order n bits of a V-signal, among (2^{l}×2^{l}×2^{l}) combinations specified by gradation steps of an 1-bit Y-signal, gradation steps of an 1-bit U-signal, and gradation steps of an 1-bit V-signal.

Of Y-, U-, and V-signals, a Y-signal is a signal indicating so-called brightness. A U-signal is the first color difference signal (B-Y signal) obtained by subtracting a Y-signal from a B-signal, and is a signal indicating so-called blueness. A V-signal is the second color difference signal (R-Y signal) obtained by subtracting a Y-signal from an R-signal, and is a signal indicating so-called redness. Hence, a change in gradation steps of a U-signal and a V-signal gives a relatively large influence on a change in colors of transmitted lights emitted from the liquid crystal panels 410 through 430, whereas a change in gradation steps of a Y-signal gives a relatively small influence on a change in colors of transmitted lights emitted from the liquid crystal panels 410 through 430.

Hence, as has been described, the 3D-LUT 130 is configured to reduce a memory capacity needed to create a 3D-LUT by making the number of gradation steps of a Y-signal smaller than the number of gradation steps of a U-signal and a V-signal, by giving 2^{m} as the number of gradation steps of a Y-signal inputted therein and 2ⁿ (n>m) as the number of gradation steps of a U-signal and a V-signal.

For instance, given p=4 for the number of higher-order bits, p, of R-, G-, and B-signals to be inputted into the 3D-LUT, which is a 3D-LUT configured to store correction values corresponding to respective combinations of gradation steps of R-, G-, and B-signals (hereinafter, also referred to simply as RGB 3D-LUT), then the number of combinations of gradation steps of R-, G-, and B-signals, Krgb, is obtained by:
Krgb=2⁴×2⁴×2⁴=16³=4096

Meanwhile, for the 3D-LUT 130 of this example, given n=4, as with the number of higher-order bits, p, of R-, G-, and B-signals, for the number of higher-order bits, n, of a U-signal and a V-signal inputted therein, and m=2, which is smaller than the number of higher-order bits, p, of R-, G-, and B-signals, for the number of higher-order bits, m, of a Y-signal, then the number of combinations of gradation steps of Y-, U-, and V-signals, Kyuv, is obtained by:
Kyuv=2²×2⁴×2⁴×16×16=1024
It is thus possible to reduce the number of combinations of gradation steps of Y-, U-, and V-signals, Kyuv, to one fourth of the number of combinations of gradation steps of R-, G-, and B-signals, Krgb.

Hence, by forming the 3D-LUT 130 of this example from a 3D-LUT (hereinafter, also referred to simply as a YUV 3D-LUT) to store correction values corresponding to respective combinations of gradation steps of Y-, U-, and V-signals, and making the number of higher-order bits of a Y-signal inputted therein smaller than the number of higher-order bits of the other U- and V-signals, it is possible to reduce a memory capacity needed to create a 3D-LUT in comparison with an RGB 3D-LUT. In addition, because the number of gradation steps of U- and V-signals that have a large influence on a change in colors can be equal to the number of gradation steps of R-, G-, and B-signals to be inputted into the RGB 3D-LUT in the background art, it is possible to suppress deterioration in accuracy of color correction.

Conversely, by forming the 3D-LUT 130 of this example from a YUV 3D-LUT on the assumption that the number of combinations of gradation steps of Y-, U-, and V-signals, Kyuv, can be as large as the number of combinations of gradation steps of R-, G-, and B-signals, Krgb, in the RGB 3D-LUT, then, by making the number of higher-order bits of a Y-signal inputted therein smaller, the number of higher-order bits of a U-signal and a V-signal can be greater than the number of bits of R-, G-, and B-signals in the RGB 3D-LUT.

For instance, given m=2 for the number of higher-order bits, m, of a Y-signal, and n=5 for the number of higher-order bits, n, of a U-signal and a V-signal, then the number of combinations of gradation steps of Y-, U-, and V-signals, Kyuv, is obtained by:
Kyuv=2²×2⁵×2⁵=4×32 ×32 =4096
This is equal to the number of combinations, Krgb, when p=16 is given for the number of higher-order bits, p, of R-, G-, and B-signals to be inputted into the RGB 3D-LUT.

Hence, by forming the 3D-LUT 130 of this example from a YUV 3D-LUT, and by making the number of higher-order bits of a Y-signal inputted therein smaller than the number of higher-order bits, p, of R-, G-, and B-signals to be inputted in the RGB 3D-LUT, it is possible to make the number of higher-order bits of a U-signal and a V-signal inputted therein larger than the number of higher-order bits of R-, G-, and B-signals to be inputted into the RGB 3D-LUT, while keeping a memory capacity needed to create a 3D-LUT as small a size as that of the RGB 3D-LUT. Consequently, accuracy of color correction can be enhanced.

C. Modifications

It should be understood that the invention is not limited to the example and the exemplary embodiment described above, and can be implemented in various manners without deviating from the scope of the invention.

The example above described, by way of example, the 3D-LUT 130 configured to store, as correction values, the offset values dy, du, and dv corresponding to the respective combinations of gradation steps of Y-, U-, and V-signals. However, the invention is not limited to this configuration, and it may be configured to store correction values equivalent to Y-, U-, and V-signals Y2, U2, and V2 outputted respectively from the addition circuits 141 through 143 in the color correction circuit portions 120. In the case of this configuration, the addition circuits 141 through 143 can be omitted. In should be noted, however, that because the offset values dy, du, and dv are generally values smaller than the gradation values of Y-, U-, and V-signals Y2, U2, and V2, a memory capacity needed to create a 3D-LUT can be reduced by the configuration to store the offset values dy, du, and dv as with the example above, rather than by the configuration to store the correction values equivalent to Y-, U-, and V-signals Y2, U2, and V2.

The example above described the configuration that the color correction circuit 100 includes the YUV conversion circuit portion 110 to convert R-, G-, and B-signals to Y-, U-, and V-signals, and the RGB conversion circuit portion 150 to convert Y-, U-, and V-signals to R-, G-, and B-signals. However, the invention is not limited to this configuration. For example, when image signals to be inputted into the liquid crystal projector 500 are in the form of Y-, U-, and V-signals, the YUV conversion circuit portion 110 is not necessarily provided by outputting the image signals from the input signal processing circuit 200 in the form of Y-, U-, and V-signals. In addition, when the R-, G-, and B-liquid crystal panels 410 through 430 are configured for Y-, U-, and V-signals to be inputted therein, the RGB conversion circuit portion 150 is not necessarily provided.

The above example described the configuration in which the color correction circuit portion 120 finds from the 3D-LUT 130 correction values corresponding to respective combinations specified by the gradation steps represented by higher-order m bits of a Y-signal, gradation steps represented by higher-order n bits of a U-signal, and gradation steps represented by higher-order n bits of a V-signal from 1-bit Y-, U-, and V-signals inputted therein, and adds the correction values thus found to corresponding Y-, U-, and V-signals, whereas gradation steps represented by (1-m) bits of a Y-signal, gradation steps represented by (1-n) bits of a U-signal, and gradation steps represented by (1-n) bits of a V-signal are neglected in the 3D-LUT 130. However, it should be understood that the invention is not limited to this configuration. For example, an interpolation circuit may be provided between the 3D-LUT 130 and the addition circuits 141 through 143, so that correction values in response to gradation steps represented by (1-m) bits of a Y-signal, gradation steps represented by (1-n) bits of a U-signal, and gradation steps represented by (1-n) bits of a V-signal are interpolated on the basis of correction values found from the 3D-LUT 130.

The above example described a case where the YUV conversion circuit portion 110 converts 1-bit R-, G-, and B-signals to 1-bit Y-, U-, and V-signals. However, R-, G-, and B-signals may be converted to Y-, U-, and V-signals of a different number of bits. Alternatively, they may be converted to Y-, U-, and V-signals each having a different number of bits.

In addition, in the example above, higher-order n bits of U- and V-signals are inputted into the 3D-LUT 130, however, the number of bits may be different for each signal. Also, each of the correction values dy, du and dv outputted from the 3D-LUT 130 may have a different number of bits instead of having the same number of bits.

Further, the above example described a case where the color correction circuit portion 120 outputs 1-bit Y-, U-, and V-signals, and the RGB conversion circuit portion 150 converts 1-bit Y-, U-, and V-signals to 1-bit R-, G-, and B-signals. However, it should be understood that the invention is not limited to this configuration. The color correction circuit portion 120 may output Y-, U-, and V-signal each having a different number of bits. The RGB conversion circuit portion 150 may convert Y-, U-, and V-signals each having a different number of bits to R-, G-, and B-signals having the same number of bits.

In addition, the example above described, by way of example, a case where the RGB conversion circuit portion 150 converts 1-bit Y-, U-, and V-signals to 1-bit R-, G-, and B-signals, however, it may convert Y-, U-, and V-signals to R-, G-, and B-signals having a different number of bits from that of Y-, U-, and V-signals.

In short, it should be understood that the invention is not limited to the example above and each signal can be formed to have any number of bits, except for the condition that the number of higher-order bits of a Y-signal inputted into the 3D-LUT 130 is smaller than the number of higher-order bits of a U-signal and a V-signal.

The example and modifications above described, by way of example, a case where image signals in the form of Y-, U-, and V-signals are inputted into the color correction circuit portion. However, the invention is not limited to this configuration. The invention is applicable to a case where image signals of various kinds in the form of a luminance signal and two color difference signals of the same type as Y-, U-, and-V-signals, for example, Y-, Cb-, and Cr-signals, or Y-, Pb-, and Pr-signals, are inputted into the color correction circuit portion. Also, the invention is applicable to a case where image signals in the form of a brightness signal, a color saturation signal, and a hue signal are inputted into the color correction circuit portion.

The example above described, by way of example, a liquid crystal projector to which the color correction circuit of the invention is applied. However, the invention is not limited to a liquid crystal projector, and can be applied to an image display devices of various kinds.

Further, while this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the invention.

1. A color correction circuit to correct a color of an image displayed on an image display device, the color correction circuit, comprising:
a color correction circuit portion, including a three-dimensional look-up table, that corrects gradation steps of a luminance signal, a first color difference signal, and a second color difference signal with the use of correction values stored in the three-dimensional look-up table in response to combinations of gradation steps of the luminance signal, the first color difference signal, and the second color difference signal inputted therein,
the three-dimensional look-up table storing, as the correction values, correction values corresponding to (2^{m}×2ⁿ×2^{o}) combinations specified by gradation steps represented by higher-order m bits (m is an integer equal to 1 or greater) of the luminance signal, gradation steps represented by higher-order n bits (n is an integer greater than m) of the first color difference signal, and gradation steps represented by higher-order o bits (o is an integer grater than m) of the second color difference signal, among (2^{j}×2^{k}×2^{l}) combinations specified by gradation steps of the luminance signal of j bits (j is an integer equal to 2 or greater), gradation steps of the first color difference signal of k bits (k is an integer equal to 2 or greater), and gradation steps of the second color difference signal of 1 bits (l is an integer equal to 2 or greater).

2. The color correction circuit according to claim 1, further comprising:
a first color conversion circuit portion that converts the luminance signal, the first color difference signal, and the second color difference signal, which have been corrected in the color correction circuit portion, to a red signal corresponding to red, a green signal corresponding to green, and a blue signal corresponding to blue.

3. The color correction circuit according to claim 2, further comprising:
a second color conversion circuit portion that converts the red signal, the green signal, and the blue signal inputted therein as image signals to the luminance signal, the first color difference signal, and the second color difference signal to be inputted into the color correction circuit portion.

4. The color correction circuit according to claim 1:
the three-dimensional look-up table storing, as the correction values, a luminance signal offset value, a first color difference signal offset value, and a second color difference signal offset value to be added, respectively, to the luminance signal, the first color difference signal, and the second color difference signal; and
the color correction circuit portion including three addition circuits to add the luminance signal offset value, the first color difference signal offset value, and the second color difference offset value, respectively, to the corresponding luminance signal, first color difference signal, and second color difference signal.

5. An image display device, including the color correction circuit according to claim 1.
